(19) United States
(12) Patent Application Publication
(10) Pub. No.: US 2016/0158781 A1
(43) Pub. Date: Jun. 9, 2016

(54) Cosmetic Container

(71) Applicant: MINJIN CO.,LTD., Gyeonggi-do (KR)

(72) Inventor: Keun Seo KI, Suwon (KR)

(21) Appl. No.: 14/905,421

(22) PCT Filed: May 19, 2014
(86) PCT No.: PCT/KR2014/004442

§ 371 Date: Jan. 15, 2016

(30) Foreign Application Priority Data
Jul. 26, 2013 (KR) 10-2013-0088896

(51) Int. Cl. B05B 11/00; A45D 34/06; A45D 40/24

(52) U.S. Cl. CPC B05B 11/3084; A45D 40/24; A45D 34/06; B05B 11/3052; B05B 11/0078

(57) ABSTRACT

The present invention provides a cosmetic container that includes: a first container (100) that keeps a first component; a second container (200) that keeps a second component that is smaller in viscosity than the first component; a first airless pump module (300) that includes a first suction tube (310) and a first transport pipe (320) communicating with the first suction tube (310), and is mounted on the first container (100); a second airless pump module (400) that includes a second suction tube (410) having a smaller diameter than the diameter of the first suction tube (310) and a second transport pipe (420) communicating with the second suction tube (410) and having a smaller diameter than the diameter of the first transport pipe (320), and is mounted on the second container (200); a pressing unit (500) that is disposed over the first airless pump module (300) and the second airless pump module (400) to simultaneously press the first airless pump module (300) and the second airless pump module (400); and a nozzle pipe (600) that is disposed in the pressing unit (500), has a nozzle tip (610) at the end, is disposed perpendicular to the first transport pipe (320) and the second transport pipe (420), and is formed such that a first distance from a discharge hole (321) of the first transport pipe (320) to the nozzle tip (610) is smaller than a second distance from a discharge hole (421) of the second transport pipe (420) to the nozzle tip (610). Accordingly, it is possible to discharge components that are different in viscosity uniformly in the same amount.

### TECHNICAL FIELD

The present invention relates to a cosmetic container, and more particularly, a dual type cosmetic container that can keep and dispense two kinds of components.

### BACKGROUND ART

Most containers for keeping a make-up use an airless pump type. Those cosmetic containers are convenient to dispense a predetermined amount of liquid-state or emulsion type make-up, and particularly, dispense a small amount of make-up kept therein, so the make-up is prevented from coming in contact with air and the entire make-up is prevented from being contaminated.

On the other hand, dual type cosmetics providing two effects with one product have been on the market. Those cosmetics separately keep two kinds of components in one container and mix them in use. Those cosmetics can emphasize the inherent features of the component to customers, in addition to increasing the function of the components, so they contribute to increasing the commercial value of products.

There is a need for a cosmetic container that has a structure separately keeping components and can dispense them in order to keep and dispense the dual type cosmetics.

A cosmetic container having two airless pumps has been disclosed in Korean Utility Model Application Publication No. 2013-0003847 (published on 28 Jun., 2013, hereafter, called this document). The cosmetic container proposed in this document has a receiving unit that can separately keep different make-ups in a container body and includes two airless pumps disposed in parallel over the receiving unit.

A push button is provided on the two airless pumps, and two discharge pipe and two discharge holes are formed in the push button, so when the push button is pressed, components are discharged from the two airless pumps to the outside through the discharge pipes and the discharge holes.

In this case, with respect to the two airless pumps, the lengths from the discharge pipes to the discharge holes, the lengths of the discharge pipes, and the positions of the discharge holes are the same, so when the push button is pressed once, the same amount of components is discharged from the two discharge holes.

However, the components may be different in viscosity, so they may be discharged in different amounts when a user presses the push button once. In particular, when the viscosity difference is large, the discharged amounts may be largely different. When the difference of discharged amount of the components is large, any one of the components is left and thrown away.

In general, considering that two components having different functions are combined in a product and they may be largely different in viscosity, this problem greatly reduces the commercial value of the product.

### DISCLOSURE

### Technical Problem

Accordingly, in order to solve the problems, an object of the present invention is to provide a cosmetic container that can uniformly discharge the same amount of components that are different in viscosity.

### Technical Solution

In order to achieve the object, a cosmetic container comprising: a first container 100 that keeps a first component; a second container 200 that keeps a second component that is smaller in viscosity than the first component; a first airless pump module 300 that includes a first suction tube 310 and a first transport pipe 320 communicating with the first suction tube 310, and is mounted on the first container 100; a second airless pump module 400 that includes a second suction tube 410 having a smaller diameter than the diameter of the first suction tube 310 and a second transport pipe 420 communicating with the second suction tube 310 and having a smaller diameter than the diameter of the first transport pipe 320, and is mounted on the second container; a pressing unit 500 that is disposed over the first airless pump module 300 and the second airless pump module 400 to simultaneously press the first airless pump module 300 and the second airless pump module 400; and a nozzle pipe 600 that is disposed in the pressing unit 500, has a nozzle tip 610 at the end, is disposed perpendicular to the first transport pipe 320 and the second transport pipe 420, and is formed such that a first distance from a discharge hole 321 of the first transport pipe 320 to the nozzle tip 610 is smaller than a second distance from a discharge hole 421 of the second transport pipe 420 to the nozzle tip 610.

Preferably, the cosmetic container may further include a base 700 that is coupled to the lower portions of the first container 100 and the second container 200 such that the first container 100 and the second container 200 make one container body.

Preferably, the nozzle tip 610 may be disposed on a virtual extending line connecting the discharge hole 321 of the first transport pipe 320 and the discharge hole 421 of the second transport pipe 420.

Preferably, the first container 100 and the second container 200 may be combined to make a cylindrical container body, and concave contact sides and convex contact sides that are in contact with each other may be formed on the first container 100 and the second container 200.

### Advantageous Effects

According to the cosmetic container of the present invention, there is provided a nozzle pipe connecting transport pipes of two airless pump modules, the nozzle pipe and the transport pipes are perpendicular to each other, and the discharge hole of the transport pipe of the airless pump module in the container keeping a component having relatively large viscosity is formed close to the nozzle tip of the nozzle pipe in comparison to the discharge hole of the transport pipe of the other airless pump module, so it is possible to discharge components that are different in viscosity uniformly in the same amount.

### DESCRIPTION OF DRAWINGS

FIG. 1 is a cross-sectional view of the cosmetic container according to an embodiment of the present invention.

FIG. 2 is an exploded perspective view of the cosmetic container illustrated in FIG. 1.

FIG. 3 is a view illustrating a first container and a second container combined with each other.

FIG. 4 is a view illustrating a pressing unit and a nozzle pipe illustrated in FIG. 1.

FIG. 5 is a view illustrating a discharge hole of a first transport pipe, a discharge hole of a second transport pipe, and a nozzle tip that are aligned in the same line.

### BEST MODE

Hereinafter, embodiments of the present invention will be described in detail with reference to the accompanying drawings. First, in the specification, in giving reference numerals to components throughout the drawings, it should be noted that like reference numerals designate like components even though the components are illustrated in different drawings. Further, although exemplary embodiments of the present invention will be described hereafter, the spirit of the present invention is not limited thereto and may be modified and implemented in various ways by those skilled in the art.

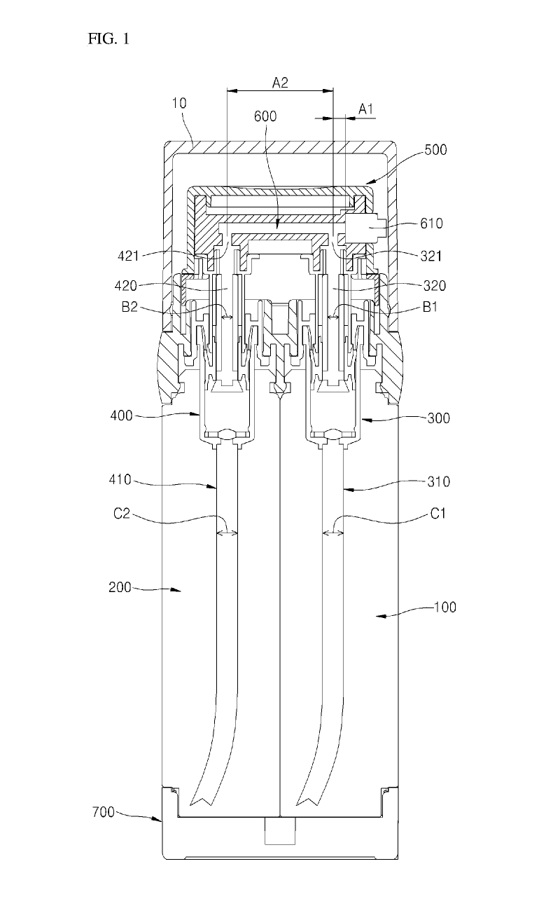

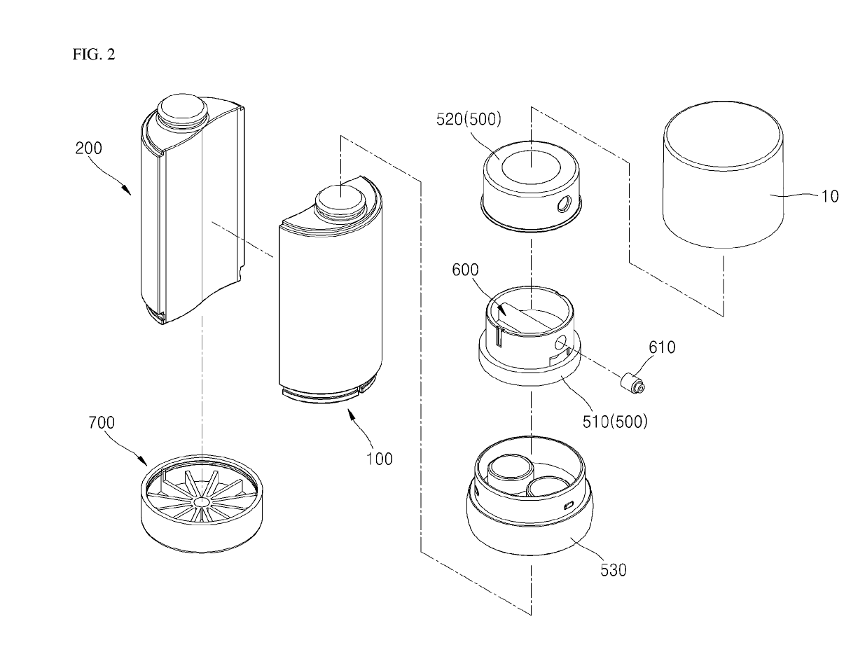

FIG. 1 is a cross-sectional view of the cosmetic container according to an embodiment of the present invention and FIG. 2 is an exploded perspective view of the cosmetic container illustrated in FIG. 1. FIGS. 1 and 2 illustrates only main characteristic parts for conceptually clear understanding of the present invention, so various modifications are expected in the figures and the scope of the present invention is not limited to the specific shapes illustrated in the figures.

Referring to FIGS. 1 and 2, a cosmetic container according to an embodiment of the present invention includes a first container 100, a second container 200, a first airless pump module 300, a second airless pump module 400, a pressing unit 500, a nozzle pipe 600, and a base 700.

The first container 100 and the second container 200 may form a container body by being combined with each other. The first container 100 and the second container 200 each have a space for keeping a component and the spaces may have the same volume.

A first component may be kept in the first container 100 and a second component may be kept in the second container 200. In this case, the second component is smaller in viscosity than the first component.

The first container 100 and the second container 200 may be combined to make a cylindrical container body, and concave areas and convex areas of the contact sides of the first container 100 and the second container 200 may be in contact with each other.

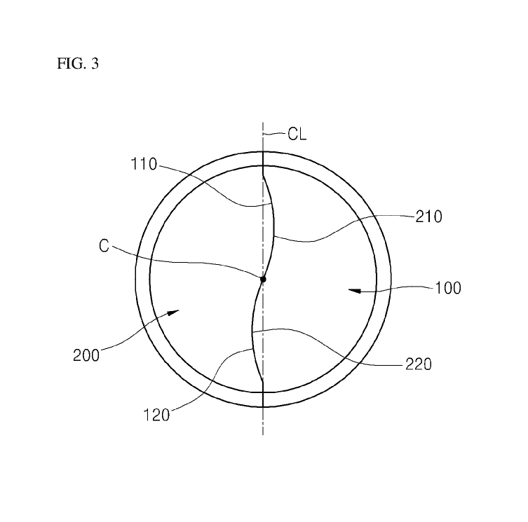

FIG. 3 is a plan view illustrating the first container and the second container combined with each other. Referring to FIG. 3, in detail, assuming that the first container 100 and the second container 200 are combined in a cylinder, a concave area 110 and a convex area 120 of the contact side of the first container 100 may be symmetrically formed with respect to a center line C passing the cross-sectional center C of the cylinder. Further, similarly, a convex area 210 corresponding to the concave area 110 of the first container 100 and a concave area 220 corresponding to the convex area 120 of the first container 100 may be formed on the contact side of the second container 200.

The first container 100 and the second container 200 can be firmly combined by this structure.

Referring to FIG. 2, the first container 100 and the second container 200 can be combined by the base 700 and a shoulder 530.

Next, the first airless pump module 300 and a second airless pump module 400 are described with reference to FIGS. 1 to 3.

The first airless pump module 300 is mounted on the first container 100. The second airless pump module 400 is mounted on the second container 200.

The first airless pump module 300 may have a first suction tube 310 at the lower portion and a first transport pipe 320 connected to the first suction tube 310. The first suction tube 310 communicates with the space in the first container 100 and sucks the first component. The first transport pipe 320 guides the first component sucked through the first suction tube 310 to the nozzle pipe 600.

The second airless pump module 400 may have a second suction tube 410 at the lower portion and a second transport pipe 420 connected to the second suction tube 410. The second suction tube 410 communicates with the space in the second container 200 and sucks the second component. The second transport pipe 420 guides the second component sucked through the second suction tube 410 to the nozzle pipe 600.

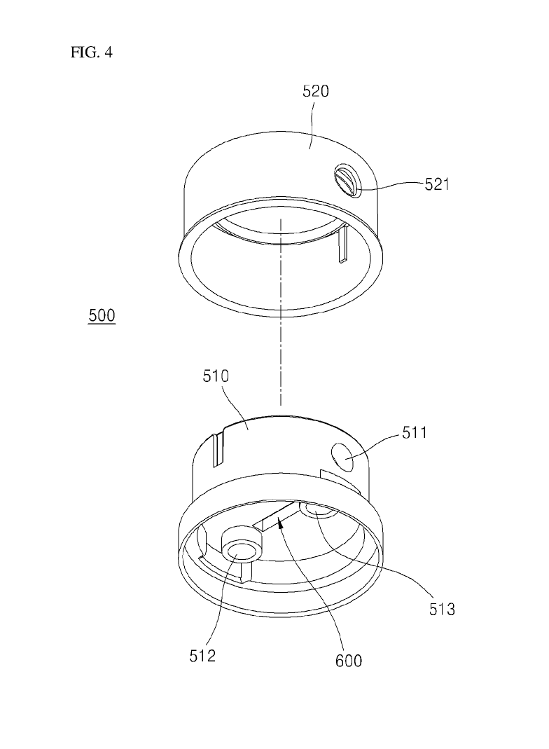

FIG. 4 is a view illustrating the pressing unit and the nozzle pipe illustrated in FIG. 1.

Next, the pressing unit 500 is described with reference to FIGS. 1 to 4. The pressing unit 500 is formed over the first airless pump module 300 and the second airless pump module 400. When a user presses the pressing unit 500, the internal pressure of the first airless pump module 300 and the second airless pump module 400 is simultaneously increased and the first and second components are discharged to the nozzle pipe 600.

The pressing unit 500 may have a lower body 510 receiving the nozzle pipe 600, an upper body 520, and the shoulder 530. In the lower body 500, the nozzle pipe 600 is horizontally disposed and a first transport pipe coupler 512 and a second transport pipe coupler 513 that communicate with the nozzle pipe 600 may be formed. The first transport pipe 320 is fitted in the first transport pipe coupler 512. The second transport pipe 320 is fitted in the second transport pipe coupler 513.

A first nozzle tip hole 511 connected with the nozzle pipe 600 may be formed at the side of the lower body 510.

The upper body 520 may be fitted on the lower body 510 and may have a second nozzle tip hole 521 at the side to communicate with the first nozzle tip hole 511.

Referring to FIG. 3, the shoulder 530 may have a space at the upper portion where the lower body 510 is seated and a space at the lower portion where the first container 100 and the second container 200 are fitted.

Next, the nozzle pipe 600 is described.

Referring to FIGS. 1, 2, and 4, the nozzle pipe 600 is horizontally disposed in the pressing unit 500. That is, the nozzle pipe 600 is perpendicular to the first transport pipe 320 and the second transport pipe 420. The nozzle pipe 600 communicates with the discharge hole 321 of the first transport pipe 320 and the discharge hole 421 of the second transport pipe 420 at the same time. The nozzle tip 610 is connected to the end of the nozzle pipe 600.

The first component and the second component transported through the first transport pipe 320 and the second transport pipe 420 are sent to the nozzle pipe 600 through the discharge holes 321 and 421, respectively.

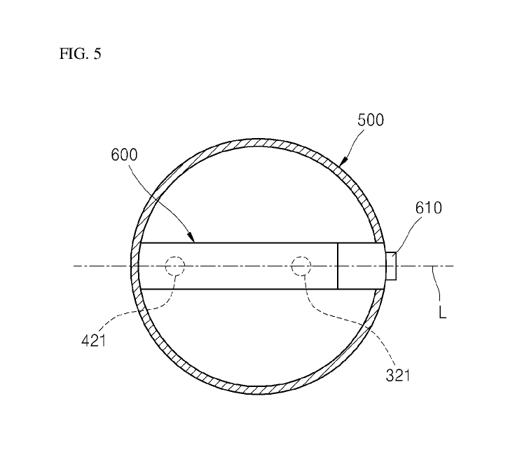

FIG. 5 is a view illustrating the discharge hole of the first transport pipe, the discharge hole of the second transport pipe, and the nozzle tip that are aligned in the same line.

In the cosmetic container according to an embodiment of the present invention, the nozzle tip 610 is formed at the side and the nozzle pipe 600 is horizontally disposed. In an embodiment, the nozzle pipe 600 may be formed such that the nozzle tip 610 is disposed on a virtual extending line L connecting the discharge hole 321 of the first transport pipe 320 (in FIG. 1) and the discharge hole 421 of the second transport pipe 420 (in FIG. 1), as illustrated in FIG. 5.

The configuration of the cosmetic container that uniformly discharge the first component and the second components that are different in viscosity in the same amount is described in detail with reference to FIG. 1.

As illustrated in FIG. 1, the first distance from the discharge hole 321 of the first transport pipe 320 to the nozzle tip 610 in the longitudinal direction of the nozzle pipe 600 is A1. The second distance from the discharge hole 421 of the second transport pipe 420 to the nozzle tip 610 in the longitudinal direction of the nozzle pipe 600 is A2.

Meanwhile, the diameter of the first transport pipe 320 is B1 and the diameter of the second transport pipe 420 is B2. The diameter of the first suction tube 310 is C1 and the diameter of the second suction tube 320 is C2.

Since the first component in the first container 100 is larger in viscosity than the second component in the second container 200, the discharge speed and amount by pumping are necessarily small. Accordingly, A1 is smaller than A2 in the cosmetic container according to an embodiment of the present invention. This is for discharging the second component in the same amount as the first component from the nozzle tip 610 by increasing displacement of the second component through the nozzle pipe 600, because the discharge speed of the second component is larger than the discharge speed of the first component. In this case, A1 and A2 may be appropriately designed in consideration of the viscosity difference between the first component and the second component.

Further, the first transport pipe 320 and the second transport pipe 420 may be designed such that B2 is smaller than B1. Further, the first suction tube 310 and the second suction tube 320 may be designed such that C2 is smaller than C1. This is for discharging the second component in the same amount as the first component from the nozzle tip 610 by decreasing the area of the nozzle pipe 600 through which the second component passes.

As described above, the cosmetic container according to an embodiment of the present invention has an internal structure such that a component having relatively small viscosity of two components has large displacement and a small movement area, so it is possible to discharge components that are different in viscosity uniformly in the same amount.

The above description is an example that explains the spirit of the present invention and may be changed, modified, and replaced in various ways without departing from the basic features of the present invention by those skilled in the art. Accordingly, the embodiment described herein and the accompanying drawings re provided not to limit, but to explain the spirit of the present invention and the spirit and the scope of the present invention are not limited by the embodiments and the accompanying drawings. The protective range of the present disclosure should be construed on the basis of claims and all the technical spirits in the equivalent range should be construed as being included in the scope of the right of the present disclosure.

1. A cosmetic container comprising:
a first container (100) that keeps a first component;
a second container (200) that keeps a second component that is smaller in viscosity than the first component;
a first airless pump module (300) that includes a first suction tube (310) and a first transport pipe (320) communicating with the first suction tube (310), and is mounted on the first container (100);
a second airless pump module (400) that includes a second suction tube (410) having a smaller diameter than the diameter of the first suction tube (310) and a second transport pipe (420) communicating with the second suction tube (410) and having a smaller diameter than the diameter of the first transport pipe (320), and is mounted on the second container (200);
a pressing unit (500) that is disposed over the first airless pump module (300) and the second airless pump module (400) to simultaneously press the first airless pump module (300) and the second airless pump module (400); and
a nozzle pipe (600) that is disposed in the pressing unit (500), has a nozzle tip (610) at the end, is disposed perpendicular to the first transport pipe (320) and the second transport pipe (420), and is formed such that a first distance from a discharge hole (321) of the first transport pipe (320) to the nozzle tip (610) is smaller than a second distance from a discharge hole (421) of the second transport pipe (420) to the nozzle tip (610).

2. The cosmetic container of claim 1, further comprising a base (700) that is coupled to the lower portions of the first container (100) and the second container (200) such that the first container (100) and the second container (200) make one container body.

3. The cosmetic container of claim 2, wherein the nozzle tip (610) is disposed on a virtual extending line connecting the discharge hole (321) of the first transport pipe (320) and the discharge hole (421) of the second transport pipe (420).

4. The cosmetic container of claim 3, wherein the first container (100) and the second container (200) are combined to make a cylindrical container body, and concave contact sides and convex contact sides that are in contact with each other are each formed on the first container (100) and the second container (200).
